(19) United States
(12) Patent Application Publication
(10) Pub. No.: US 2024/0367750 A1
(43) Pub. Date: Nov. 7, 2024

(54) Bicycle Rear Suspension

(71) Applicant: Matthew Walter Lessmeier, Bozeman, MT (US)

(72) Inventor: Matthew Walter Lessmeier, Bozeman, MT (US)

(21) Appl. No.: 18/312,591

(22) Filed: May 5, 2023

(51) Int. Cl. B62K 25/26; B62K 3/02

(52) U.S. Cl. CPC B62K 25/26; B62K 3/02

(57) ABSTRACT

The present invention is aimed at solving the problems of current bicycle suspension linkages. In particular, it is meant to balance the tradeoff between absorbing impact force, maintaining constant handling characteristics, and efficiently transmitting motive force. The present invention includes an optimal rear axle motion path, and a dual link suspension linkage to accomplish this goal.

### CROSS-REFERENCE TO RELATED APPLICATIONS

No related applications

### TECHNICAL FIELD

The present invention is directed toward rear wheel suspension linkages for mountain bikes.

### BACKGROUND

The general problem that mountain bike rear suspension seeks to solve is that of the rear wheel bouncing over rough terrain and causing the rider to lose control. Rear suspension linkages are implemented to allow the rear wheel to move independently of the rider, so the wheel can track the terrain and maintain traction while the rider remains isolated from the bumps. Springs are connected to such linkages to provide a resisting force, and dampers are connected to those springs to lessen the impacts transmitted to the rider. Bikes meant to provide greater stability and traction in rough terrain use more rear wheel ‘travel’, meaning that the rear wheel can move a greater distance as the linkage is actuated. This is good for control in rough terrain where the goal is to damp the most energy possible to provide the smoothest feel, but handling on smooth, flat, and uphill terrain gets worse due to the loss of energy that could be used for motive force. Furthermore, these long travel bikes feel less playful due to the lag between rider input and bike response, so they are less fun to ride in corners and on jumps. This is the trade off in traditional linkage design: control in rough terrain vs. playfulness and efficiency. As a result, there are many different types of mountain bikes with rear suspension linkages on the market today: short travel ‘cross country bikes’, medium travel ‘trail bikes’, medium-long travel ‘all mountain bikes’, and long travel ‘downhill bikes’.

Rear wheel travel is not the only design variable, axle path is also controllable, but up until now, most traditional linkages, such as that described in Leitner, U.S. Pat. No. 5,899,480, use a fairly vertical rear axle path, meaning that the rear wheel moves along an arc that is roughly vertical as the suspension actuates. With a few notable exceptions, this does not vary much from cross country bike to downhill bike, or from brand to brand. One drawback of this design attribute is that the wheelbase, the distance between front and rear wheels, gets shorter as the front and rear suspension compress together. This is because the rear wheel moves approximately up, while the front moves diagonally up and back along a line at an angle dictated by the geometry of the bike frame, usually about 60-70 degrees from the horizontal. This shortening wheelbase shortens the cornering radius of the bike as it compresses, resulting in the bike becoming unstable and oversteering under large loads.

A single pivot can be easily designed to provide a rear axle path that traverses a portion of a circle tilted at an angle such that the rear wheel moves up and back. This approach is seen on the commercially available Druid and Dreadnought made by Forbidden Bikes, Cumberland, BC, CA and can limit the wheelbase shortening effect during suspension compression compared to vertical axle paths, but not enough. FIG. 1 shows the rear axle path of such a prior art design. The darker straight line is the front axle path, the lighter curved line is the rear axle path. The distance between the two lines represents the wheelbase shortening effect and is undesirable. The rear axle path shown in FIG. 1 also displays significant curvature. Even a single pivot wheel path optimized for a consistent wheelbase throughout the travel would have variability due to the curvature of the circular arc of the rear wheel path vs straight line of the front.

The design described by Pisa Canyelles in CA 2,971,081 can provide a straighter rear wheel path, and it can be configured so that the rear wheel travels up and back, but this design has other drawbacks such as the ‘leverage curve’, or ratio between rear wheel to spring displacement vs. rear wheel travel. A consistently downward sloping curve is desired, while CA 2,971,081 has an upward slope for a portion of the travel. This results in an inconsistent feel of the restoring force.

### SUMMARY

The present invention is meant to decouple the tradeoff between effective damping in rough terrain and responsive handling by better aligning the rear wheel path to absorb bump energy but also to transmit motive power from the rider. This way, these criteria that are mutually exclusive when designing based on rear wheel travel alone can be balanced to a greater degree.

To achieve this balance, the rear wheel is made to travel up and backward during suspension articulation, therefore better absorbing bump forces from roots and rocks that come at an upward and backward angle, approximately 45 degrees. The rear wheel motion path during suspension articulation is between 45 and 90 degrees from the horizontal in order to also provide effective damping of vertical forces from landing jumps and drops. The best angle in this wide range is dictated by the head tube angle, or angle that the front fork is mounted to the frame with respect to the horizontal. The head tube angle, which varies based on frame geometry but is approximately 64 degrees from the horizontal on modern mountain bikes, is chosen because it is the best at allowing the front suspension to absorb the various impacts from the front wheel. The present invention aligns the rear axle path to be as parallel as possible to the front axle path, this way providing for the optimal absorption of the various forces encountered by the bike while also providing for a more constant wheelbase during the compression of the front and rear suspension together. This approximately parallel rear wheel path allows for more efficient motive force transmission because less of the vertical center of mass movements associated with pedaling, pumping, cornering, etc. are absorbed by the suspension.

To accomplish this wheel path, the excellent ‘straight line’ mechanism of the Chebyshev Linkage is modified for the purposes described here. This linkage based on a modified Chebyshev Linkage is here termed the SYNC Link and is one aspect of this invention. The SYNC Link makes use of two links to pivotally connect the front and rear swingarms, a front and rear link. The front link has its rearward pivot fixed to the front main frame, and its forward pivot fixed to the rear swingarm. The rear link has its rearward pivot fixed to the rear swingarm, and its forward pivot fixed to the front main frame. The front link is connected to the front main frame at a pivot point above the pivot point connecting the rear link to the front main frame. The resulting axle path deviates a minimal amount from a straight line that is parallel to the front axle path and translated to start at the same point as the rear axle path. When implemented as will be described here, this linkage also provides an optimal leverage curve, that is a rear wheel travel to spring travel ratio vs. rear wheel travel that is consistent and downward sloping as desired. This lets the bike sit in the travel at a position that allows for large amounts of traction while maintaining a predictable force response. This invention also incorporates an idler pulley mounted on the frame at a location above the chain ring so as to route the drive force through a location that provides a moment (torque) which does not cause unnecessary oscillations of the suspension while pedaling. This location can be chosen so as to limit the amount of chain growth and crank rotation when the suspension compresses. This location can be on the rear swingarm, either of the two links, or the front main frame. Further combined with a brake mount fixed to the rear swingarm at an optimal angle, the brake force can be used to keep the weight balanced between front and rear wheels even under heavy braking.

### BRIEF DESCRIPTION OF THE DRAWINGS

FIG. 1 is the rear axle path of a prior art, single pivot suspension linkage.

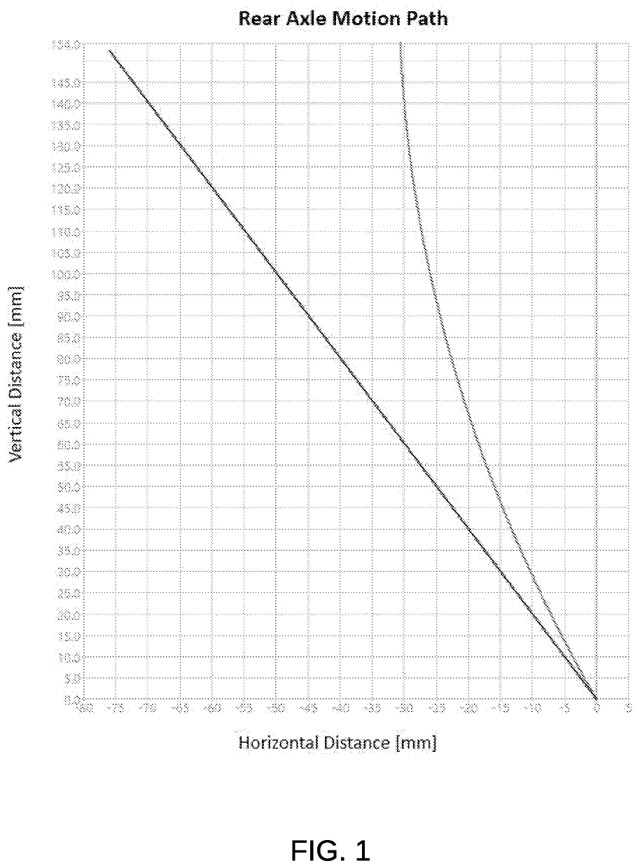

FIG. 2 is a side view of one possible embodiment of this invention and shows the entire frame as well as the relevant components that it interfaces with—axles, wheels, front fork, etc.

FIG. 3 is the rear axle path chart showing the ideal implementation and the limits of the current invention.

FIG. 4 is a side view close up of the linkage mechanism assembly of one possible embodiment.

FIG. 5 is a side view of the front main frame of one possible embodiment.

FIG. 6 is a side view of the rear swingarm of one possible embodiment.

FIG. 7A is a side view of the front link of one possible embodiment and FIG. 7B is a top view of the front link.

FIG. 8 is a top view of the rear link of one possible embodiment.

FIG. 9 is a top view of the linkage mechanism assembly of one possible embodiment.

FIG. 10 is a top view of the rear swingarm of one possible embodiment.

FIG. 11 is a side view of another embodiment of a front main frame for the present invention.

FIG. 12A is a side view of another embodiment of the front link and FIG. 12B is a top view of the front link.

### DETAILED DESCRIPTION

The present invention generally consists of two distinct links that are pivotally connected between the front and rear swingarms, with each link being either one piece or having a right and left side that are identical versions of the same part. These links are oriented within 0-30 degrees of perpendicular to one another, or more optimally within 12-22 degrees of perpendicular to one another. This linkage configuration allows for movement of the rear wheel upward and backward along a path that is approximately parallel to the motion path of the front wheel during suspension articulation.

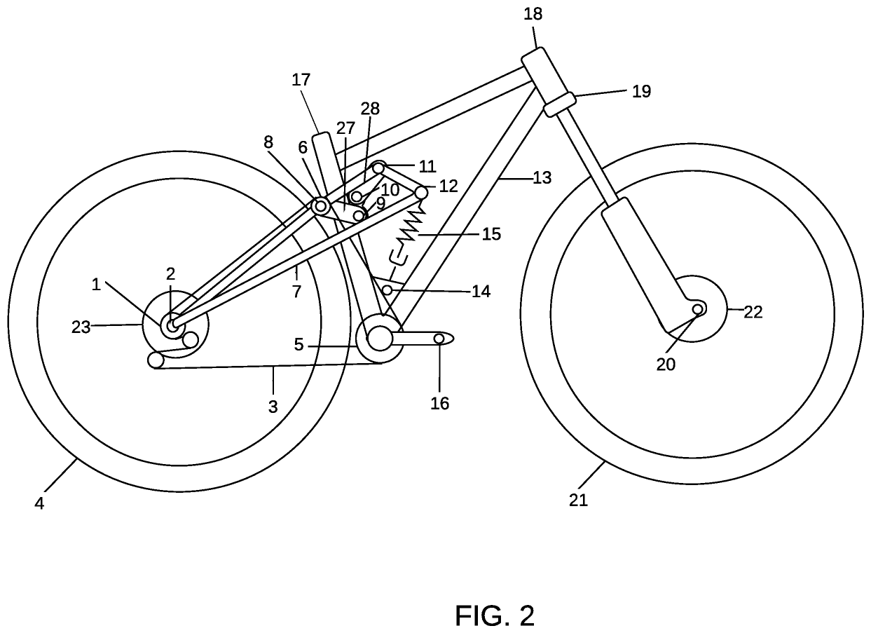

FIG. 2 shows one embodiment of the current invention, including the important components that the frame interfaces with. Sprocket, 1 drives the rear wheel, 4 under pedaling. The rear wheel, 4 may have many sprockets mounted on it each having different tooth counts, but only one is shown in FIG. 2 for simplicity. Rear axle, 2 is a separate part and connects the hub (not shown) of the rear wheel, 4 to the rear swingarm, 7. The chain, 3 transmits the drive force from the chain ring, 5 to a rear sprocket, 1. The cranks, 16 provide the means by which the rider generates motive force. The chain, 3 is furthermore routed over an idler gear, 6 to provide for an optimal rotational effect of the drive force on the rear suspension. The idler gear, 6 is shown concentric with the rear swingarm rear pivot, 8, but need not be so. The idler gear, 6 can be mounted anywhere on the rear swingarm, 7, the rear link, 27, the front link, 28, or the front main frame, 13.

The rear link, 27, connects the rear swingarm, 7 with the front main frame, 13 via the rear swingarm rear pivot, 8 and the front main frame lower pivot, 9. Similarly, the front link, 28 connects the rear swingarm, 7 with the front main frame, 13 via the rear swingarm front pivot, 11 and the front main frame upper pivot, 10. The pivots 8,9,10, and 11 are rotational joints utilizing bearings, bushings, or other mechanism supporting rotation to allow the connected members to rotate in relation to one another.

The rear shock, 15 has both a spring and damper which can be in any circuit configuration, not necessarily the series configuration implied by the depiction in FIG. 2. The depiction is simply the author's symbol for a spring and damper such as is available in commercial shock absorbers. The rear shock, 15 can utilize a coil, air, or any other type of spring and a hydraulic, viscoelastic, or any other type of damper. The rear shock, 15 is connected to the front main frame, 13 via the front main frame shock mount, 14 and the rear swingarm, 7 via the rear swingarm shock mount, 12.

The seat tube, 17 is where a seat post is inserted to provide an adjustable height seat. The head tube, 18 is where the front fork, 19 is connected to the frame via the bearings in the head set (not shown) which are inside the head tube, 18. Stem and handlebars (not shown) are attached to the top of fork steer tube (not shown) at the top of the head tube, 18. The front fork, 19 is a spring and damper, having its motion constrained to a straight line parallel to its axis via linear bushings or similar mechanism. The front fork, 19 connects to the front axle, 20 at the bottom end. The front axle 20 attaches the front wheel 21 to the front fork 19.

Disc brake rotors in the front, 22 and rear, 23 are shown to represent the brakes.

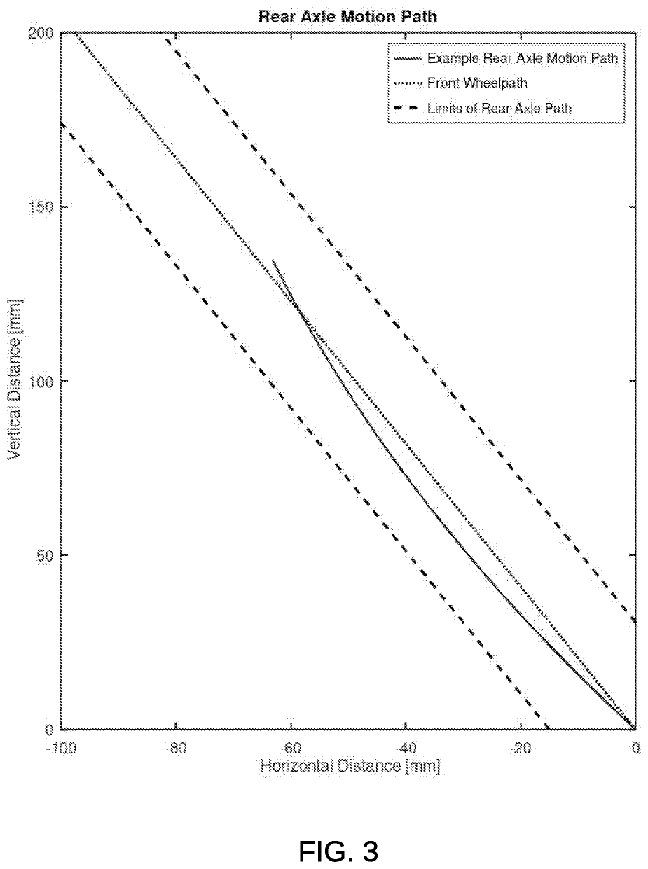

FIG. 3 shows the wheel path, or the motion path of the rear wheel axle during suspension articulation. When the wheel position, distance, travel, and/or motion path are described in the following, they are referring to the location of the wheel axle. The point defined by zero vertical distance and zero horizontal distance corresponds to full extension of the spring (15 in FIG. 2). The horizontal is the direction of the line between ground contact patches of the front and rear wheels and the vertical is the direction which is in the plane of the bike frame and perpendicular to the horizontal. The dotted line is an example of the front wheel path with a head tube angle of 64 degrees, but could be at any angle dictated by the frame and front fork geometry. The solid line is an example wheel path that embodies the present invention and could be produced by a linkage such as that shown in FIG. 2. The dashed lines are the limits of rear wheel path deviation from the front wheel path at the same amount of vertical travel and represent a forward and backward horizontal deviation of 15 mm. Travel here meaning the distance the wheel moves when the suspension is actuated to some degree. The example wheel path shown has a maximum horizontal deviation of 5 mm. For this invention to achieve the benefits previously explained, the maximum horizontal deviation of rear wheel path from front wheel path in both the forward and rearward directions should not exceed 20 mm, more optimally 15 mm, and most optimally 10 mm. The front wheel path (dotted) and limits (dashed) are extended beyond the example wheel path to show that this invention includes longer travel configurations for both the front and/or rear suspensions. Likewise, it also includes shorter travel configurations.

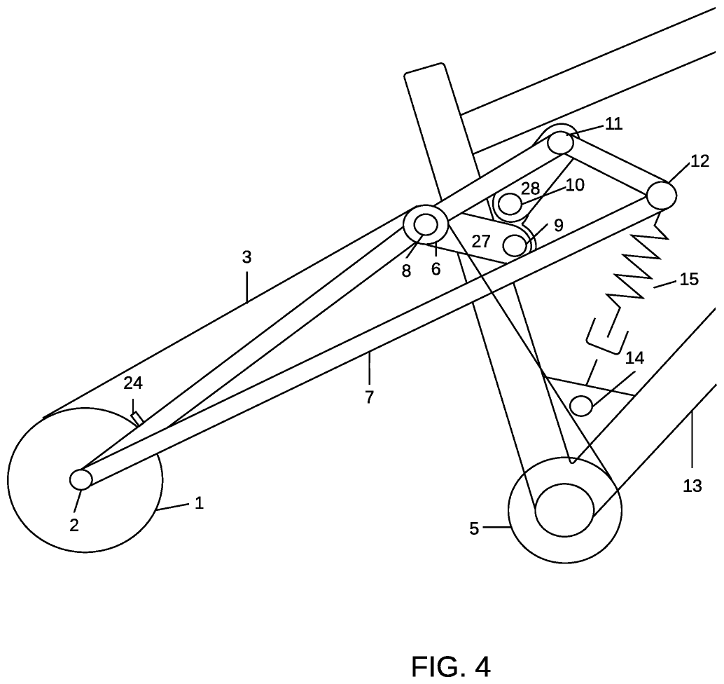

FIG. 4 is a close-up side view of a linkage that embodies this invention and in its general configuration is termed the SYNC Link. The SYNC Link is made up of a rear link, 27 and front link, 28. These links pivotally connect the front main frame, 13 to the rear swingarm, 7. The rear link is attached to the front main frame pivot, 9 and the rear swingarm pivot, 8. The front link, 28 is attached to the front main frame upper pivot, 10 and the rear swingarm front pivot, 11. These pivots are rotational connections provided by bearings, bushings, or other method known in the art and they may have such rotational elements present in the front main frame, 13, rear swingarm, 7, the links, 27 & 28, or both. The rear swingarm rear pivot, 8 is necessarily behind the rear swingarm front pivot, 11, but not necessarily above or below. Such references to direction here and throughout are referring to the horizontal being the line between contact patches of front and rear tires for fully extended front and rear suspension. The horizontal is what is being referred to when the words ‘front’ and ‘rear’ or similar are used. Likewise, the vertical is defined as the perpendicular to the horizontal being in the plane of the bike and referenced with ‘above’, ‘below’, ‘lower’, ‘upper’, and similar. The lateral direction is defined as the direction perpendicular to both horizontal and vertical directions, and is referred to with ‘right’, ‘left’ and similar which are defined as if one was riding the bike.

The front main frame upper pivot, 10 is necessarily above the front main frame lower pivot, 9, but not necessarily in front of or behind. The rear swingarm front pivot, 11 is necessarily above and in front of the front main frame upper pivot, 10. The rear swingarm rear pivot, 8 is necessarily above and behind the front main frame lower pivot, 9. The shock, 15 is necessary to provide a restoring force and impact energy dissipation, and is connected between the front main frame shock mount, 14 and the rear swingarm shock mount, 12 in FIG. 4. The front main frame shock mount, 14 is necessarily located somewhere on the front main frame, 13 and the rear swingarm shock mount, 12 is necessarily located somewhere on the rear swingarm. This is what defines the general linkage termed the SYNC Link that is one aspect of this invention. The front main frame upper pivot, 10 is preferably within 100 mm, or more preferably 50 mm, horizontally, and within 160 mm, or more preferably 90 mm, above, the front main frame lower pivot, 9. The rear swingarm front pivot, 11 is preferably within 160 mm, or more preferably 80 mm, in front of and within 160 mm, or more preferably 90 mm, above, the front main frame upper pivot, 10. The rear swingarm rear pivot, 8 is preferably within 200 mm, or more preferably 100 mm, behind, and within 150 mm, or more preferably 70 mm, above, the front main frame lower pivot, 9. The rear swingarm rear pivot, 8 is preferably between 70 mm and 240 mm, or more preferably 85 mm and 185 mm, behind the rear swingarm front pivot, 11. The SYNC Link is able to accomplish the second aspect of desirable wheel path as defined in FIG. 3, but it is important to note that the two are implementable independently.

FIG. 4 also shows the important components of the drive system of the bicycle. Notably, an idler gear, 6 is mounted on the rear swingarm rear pivot, 8 out of convenience, but it could be mounted anywhere on the rear swingarm, 7, the rear link, 27, the front link, 28, or the front main frame, 13. This location is chosen to provide an optimal torque on the bike so that the suspension does not oscillate during pedaling, and further so that the chain lengthening effect can be limited. Preventing chain lengthening of the upper chain path between the chain ring, 5 to the idler pulley, 6, and finally to the cassette sprocket, 1 is of utmost importance because it has no mechanism to take up slack such as is provided on the lower chain path (not shown) by the derailleur (also not shown). It should also be noted that there is more than one sprocket on practical cassettes, but one is shown for simplicity. The rear brake mount, 24 is mounted somewhere on the rear swingarm to provide for attachment of brake calipers.

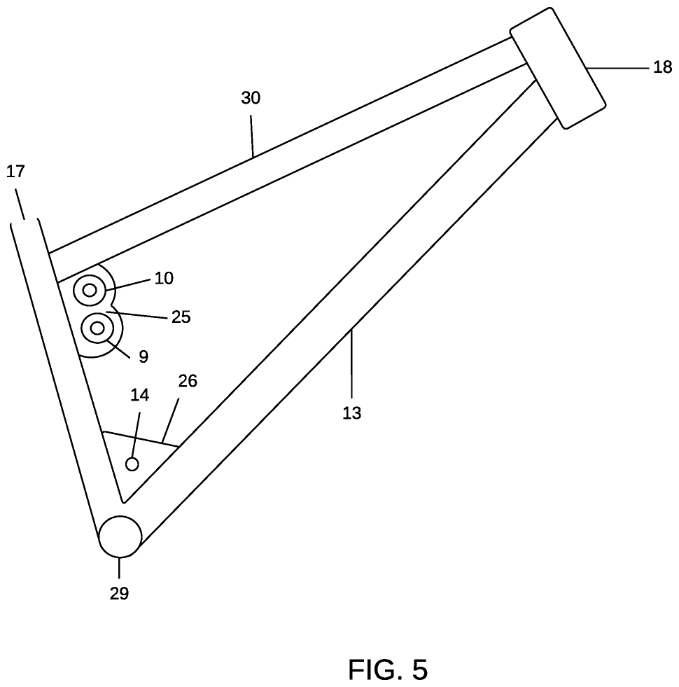

FIG. 5 shows one embodiment of the front main frame, 13 on its own. The shock mount, 14 is located at any desirable location and is supported by the shock mount gusset, 26. The front main frame lower pivot, 9 and upper pivot, 10 are supported by the bearing housing gusset, 25. Front main frame pivots, 9,10 are housings for the rotational elements—bearings, bushings, or other methods of rotational coupling. The rotational elements are assembled into the housing via an interference fit or other know method. Let it be noted that the front main frame shock mount, 14 could also utilize such a rotational connection, but need not necessarily due so as this can be provided in the shock itself. The seat tube, 17 is open at the top so as to accept a standard seat post, be it an adjustable dropper post or conventional seat post. This seat post is held in place by a clamp (not shown) at the top of the seat tube, 17. The top tube, 30 need not be in this specific orientation in relation to the front main frame upper pivot, 10, but can take any position suitable to an ergonomic frame design. The head tube, 18 is meant to accept the headset (not shown) which holds bearings that allow the steer tube of the fork (not shown) to rotate with respect to the front main frame. The stem and handlebars are attached to the steer tube on the top of the headset, on the top of the headtube, 18. The bottom bracket shell, 29 is meant to accept the bottom bracket which includes bearings for rotationally coupling the crankshaft to the front main frame, 13. All of these referenced elements are joined to their respective places by welding, brazing, carbon fiber layup, 3-d printing, machined from billet, or any other method for constructing frames.

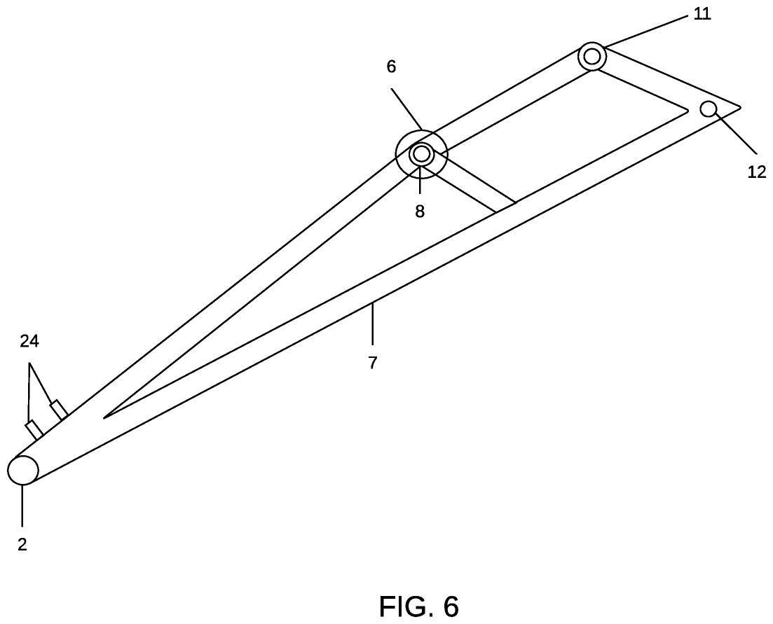

FIG. 6 shows the rear swingarm, 7 on its own. The rear swingarm, 7 connects to the rear wheel (not shown) via the rear axle, 2. The brake is mounted on the brake mount, 24 which could be affixed at any desirable location and angle. The rear swingarm shock mount, 12 can likewise be located at any convenient location. The rear swingarm front pivot, 11 is necessarily in front of the rear swingarm rear pivot, 8, but not necessarily above or below. These pivots are housings for rotationally coupling members as described previously for the other pivots. It should also be noted that the rear swingarm shock mount, 12 could also utilize such a rotational connection, but need not necessarily due so. The idler gear, 6 is in an example position and can be mounted anywhere on the rear swingarm, 7 or the other components previously mentioned. Its purpose is to route the chain force through a desirable location so as to not cause unnecessary oscillations of the suspension while pedaling.

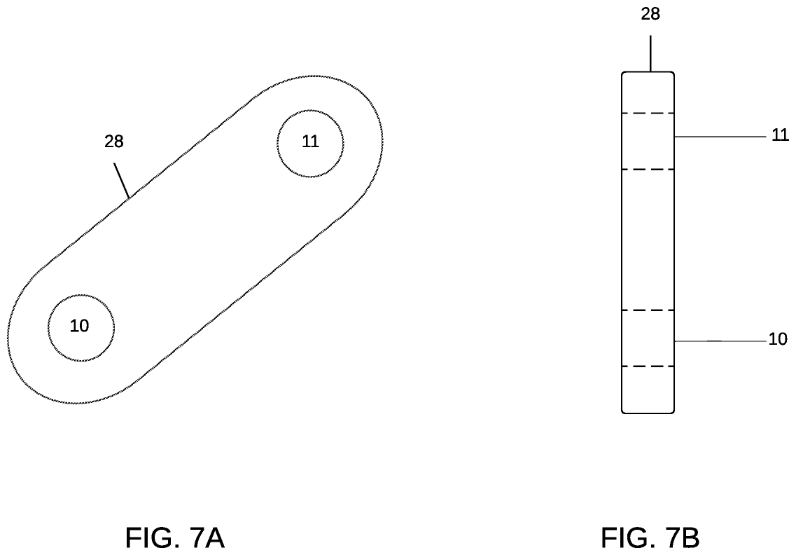

FIGS. 7A and 7B show the front link, 28 that pivotally connects the front main frame upper pivot, 10 to the rear swingarm front pivot, 11. The pivots in the front link 10,11 may or may not include housings for rotational elements. Only one front link is shown, when one on each lateral side is needed for the full assembly. These two sides may or may not be joined via a cross piece.

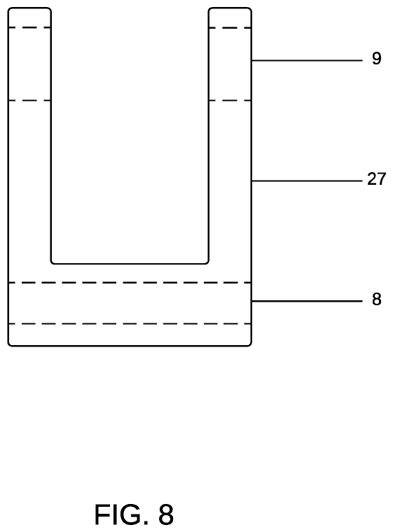

FIG. 8 shows the rear link, 27 that pivotally connects the front main frame lower pivot, 9 to the rear swingarm rear pivot, 8. The pivots in the front link, 8,9 may or may not include housings for rotational elements. The rear link, 27 is shown here with both lateral sides joined via a cross piece to provide lateral stiffness. These two sides need not necessarily be joined. Alternatively, they can be joined at any convenient location allowing clearance of the other parts of the linkage assembly during suspension articulation.

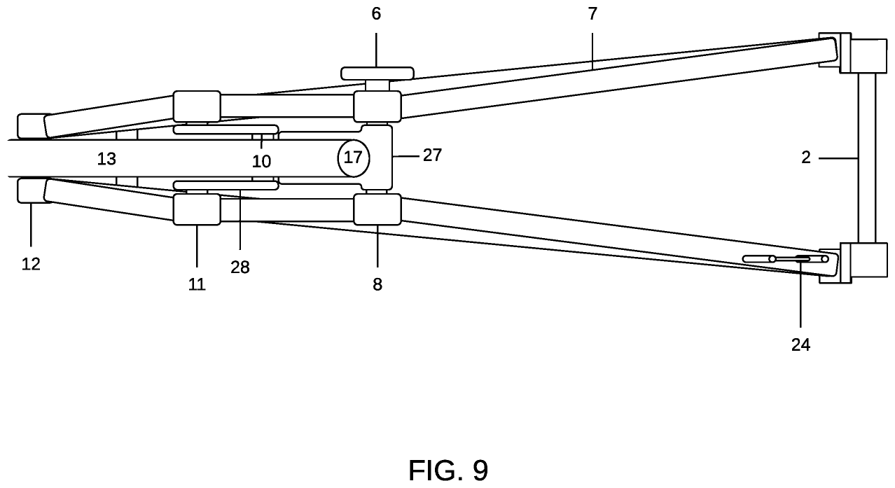

FIG. 9 shows a top view of the linkage assembly shown in FIG. 3. The rear wheel (not shown) attaches at the rear axle, 2. The brake mount, 24 can be located anywhere on the rear swingarm, 7 and is shown in the current location out of convenience. The rear swingarm rear pivot, 8 is shown and includes the rotational joint between the rear swingarm, 7 and rear link, 27. Also shown on this axis is the idler gear, 6. This is one of the desirable locations for the idler gear, 6, but it can be mounted anywhere on the rear swingarm, 7, the front main frame, 13, the rear link, 27, or the front link, 28. The seat tube, 17 is open ended at the top to accept the seat post (not shown). The front main frame top pivot, 10 rotationally connects the front main frame, 13 with the front link, 28. The rear swingarm front pivot, 11 rotationally connects the rear swingarm, 7 with the front link, 28. The rear swingarm shock mount, 12 rotationally connects the rear swingarm, 7 to the shock (not shown).

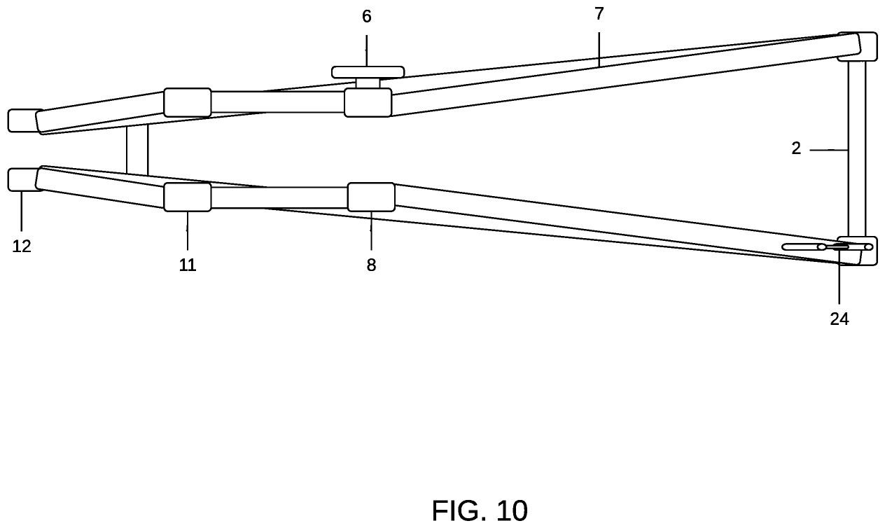

FIG. 10 shows the same view as FIG. 9 but just includes the rear swingarm and associated components for simplicity. The rear axle, 2 joins the rear wheel to the rear swingarm, 7. The rear swingarm rear pivot, 8 is where the rear link pivotally connects, and the rear swingarm front pivot, 11 is where the front link pivotally connects. The idler gear, 6 is again shown concentric with the rear swingarm rear pivot, 8, but need not be so as previously explained. The rear swingarm shock mount, 12 pivotally connects to the shock, but the rear swingarm itself may or may not have rotational elements such as bearings, bushings, etc.

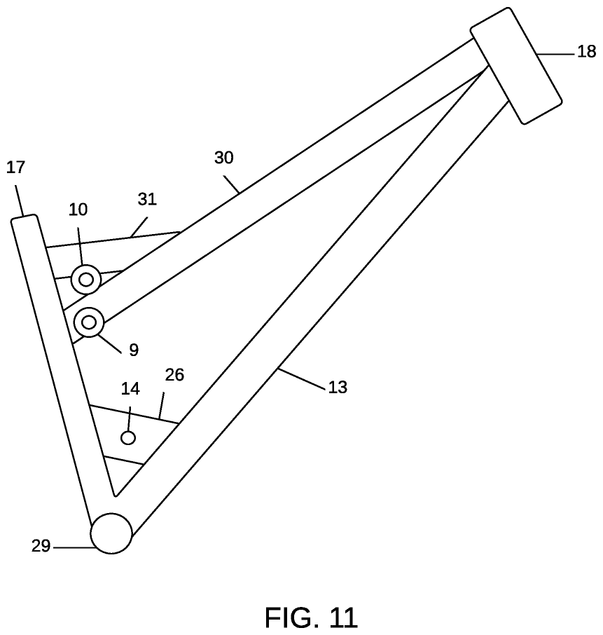

FIG. 11 has all of the elements of FIG. 5, but now shows a different top tube 30 configuration and has an additional member 31. The shock mount gusset 26 is also shown as a slightly different version than that shown in FIG. 4. FIG. 10 is meant to illustrate a different version of the front main frame 13 as an example to show how the present invention can be accomplished in a variety of ways.

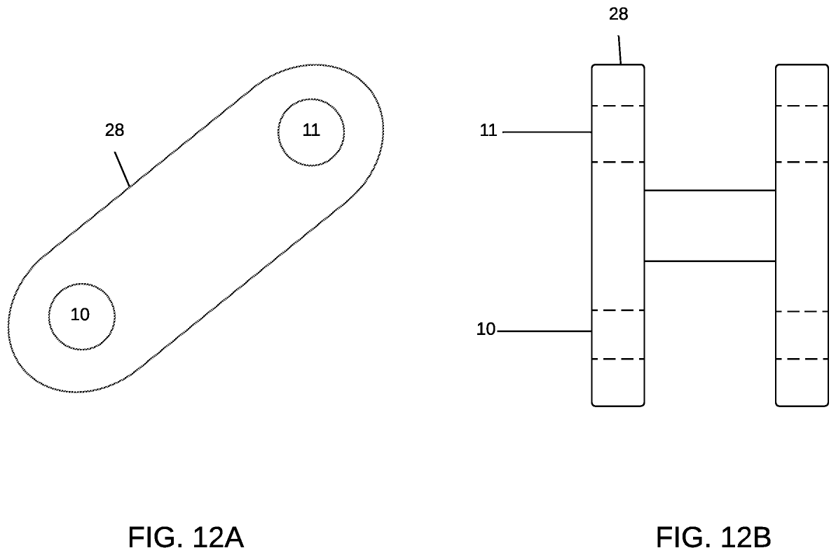

Likewise, FIGS. 12A and 12B show a different version of the front link, 28 where the two lateral sides are joined. It otherwise fulfills the same function as that described in FIGS. 7A and 7B.

This invention covers the wheel path of a suspension linkage where said wheel path is as close to parallel to a front wheel path as possible and also provides a linkage capable of achieving this. This allows for greater absorption of impact forces, greater transmission of motive forces in the case of bicycles, and more consistent handling characteristics throughout the travel of the suspension.

This invention has been described in relation to bicycles having a rear suspension linkage and a front suspension fork, but other vehicles such as dirt bikes and motorcycles could also benefit in a similar way.

Those specifications described above are the embodiments to exemplify the present disclosure to enable the person skilled in the art to understand, make, and use embodiments of the present disclosure. This description, however, is not intended to limit the scope of the present disclosure. Any equivalent modification and variation according to the spirit of the present disclosure is to be also included within the scope of the claims stated below.

The components, steps, features, benefits and advantages that have been discussed are merely illustrative. None of them, nor the discussions relating to them, are intended to limit the scope of protection in any way. Numerous other embodiments are also contemplated. These include embodiments that have fewer, additional, and/or different components, features, benefits and advantages. These also include embodiments in which the components are arranged differently, particularly the structural frame members.

The scope of protection is limited solely by the claims. That scope is intended and should be interpreted to be as broad as is consistent with the ordinary meaning of the language that is used in the claims when interpreted in light of this specification and the prosecution history that follows and to encompass all structural and functional equivalents.

1. A bicycle rear linkage system comprising:
a front link and a rear link;
a front main frame; and
a rear swingarm;
wherein the front link is pivotally connected to the front main frame at a rear of the front link and is pivotally connected to the rear swingarm at a front of the front link;
wherein the rear link is pivotally connected to the rear swingarm at a rear of the rear link and is pivotally connected to the front main frame at a front of the rear link;
a first pivotal connection of the front link to the front main frame is above a second pivotal connection of the rear link to the front main frame;
a third pivotal connection of the rear link to the rear swingarm is behind a fourth pivotal connection of the front link to the rear swingarm;
wherein the front link is pivotally connected to the rear swingarm above the first pivotal connection and the rear link is pivotally connected to the rear swingarm above the second pivotal connection;
a spring and damper is pivotally connected between the front main frame and the rear swingarm.

2. The bicycle rear linkage system of claim 1, wherein the front link and rear link each include a right half and a left half that are configured to be joined by a cross piece and wherein the rear swingarm supports a brake mount.

3. The bicycle rear linkage system of claim 1 comprising:
an idler gear mounted on the front main frame, rear swingarm, rear link, or front link;
at least one sprocket attached to a rear wheel;
a chain ring that drives the bike attached to cranks, which are attached to the front main frame via a bottom bracket shell and bottom bracket;
wherein a chain is routed over the idler gear on an upper chain path between the chain ring and the at least one sprocket.

4. A vehicle, comprising:
at least one front wheel that rotates on at least one front axle;
at least one rear wheel that rotates on at least one rear axle;
a front frame with front suspension that allows travel of the at least one front wheel along a front axle motion path;
suspension linkages;
a rear frame member, including the at least one rear axle, movably coupled to the front frame by the suspension linkages, the rear frame member allows travel of the at least one rear wheel along a rear axle motion path,
the rear axle motion path during suspension actuation is substantially parallel to the front axle motion path.

5. The vehicle of claim 4 wherein the rear axle motion path and the front axle motion path have a relative horizontal deviation between negative 20 mm and positive 20 mm at a same vertical distance of travel.

6. The vehicle of claim 4 wherein the rear axle motion path and the front axle motion path have a relative horizontal deviation between negative 15 mm and positive 15 mm at a same vertical distance of travel.

7. The vehicle of claim 4 wherein the rear axle motion path and the front axle motion path have a relative horizontal displacement between negative 10 mm and positive 10 mm at the same vertical distance of travel.

8. A linkage system comprising:
a frame member;
a swingarm;
a front link that includes:
a front pivotal connection that is above a rear pivotal connection;
a rear link, the front and rear link pivotally connect the frame member and swingarm, the rear link includes:
a rear pivotal connection that is above a front pivotal connection;
wherein the rear pivotal connection of the front link is above the front pivotal connection of the rear link.

9. The linkage system of claim 8 wherein the front pivotal connection of the front link is further from the swingarm than the rear pivotal connection of the rear link.

10. The linkage system of claim 8 wherein the frame member includes:
a seat tube;
a head tube; and
a top tube that is between the seat tube and the head tube;
an idler gear that is further from the head tube than the seat tube.

11. The linkage system of claim 10 wherein the rear link is closer to the idler gear than the front link.

12. The linkage system of claim 10, comprising a bearing housing gusset connected between the seat tube and the top tube, the bearing housing gusset having a first pivotal connection location and a second pivotal connection location, the front link being pivotally connected to the first pivotal connection location and the rear link being pivotally connected to the second pivotal connection location.

13. The linkage system of claim 12 comprising a spring and damper or shock pivotally connected between the frame member and swingarm.

14. The linkage system of claim 13 wherein the spring and damper are connected to the seat tube at a lower location than the bearing housing gusset.

15. The linkage system of claim 10, comprising a frame portion between the top tube and the seat tube, a first pivotal connection is between the frame portion and the top tube and a second pivotal connection is on a bottom side of the top tube.

16. The linkage system of claim 10 wherein the front link is connected to the first pivotal connection and the rear link is connected to the second pivotal connection.
